(19) United States
(12) Patent Application Publication
(10) Pub. No.: US 2020/0050978 A1
(43) Pub. Date: Feb. 13, 2020

(54) METHODS AND APPARATUS FOR COMMERCIAL OPERATION OF PERSONAL AUTONOMOUS VEHICLES

(71) Applicant: Ford Motor Company, Dearborn, MI (US)

(72) Inventors: Oswaldo PEREZ BARRERA, Texcoco (MX); Alvaro JIMENEZ HERNANDEZ, Miguel Hidalgo (MX); Pablo Hugo VALENCIA CHAPARRO, Mexico City (MX); Francisco Javier FERREIRA, Atizapna de Zaragoza (MX)

(21) Appl. No.: 16/469,349

(22) PCT Filed: Dec. 14, 2016
(86) PCT No.: PCT/US16/66606

§ 371 Date: Jun. 13, 2019

(51) Int. Cl. G06Q 10/02; G06Q 30/02; G06Q 50/30

(52) U.S. Cl. CPC G06Q 10/02; G06Q 50/30; G06Q 30/0265

(57) ABSTRACT

Methods, apparatus and systems for commercial operation of autonomous vehicles are disclosed. A disclosed method includes determining that an owner of a personal autonomous vehicle has authorized the autonomous vehicle for commercial use. The disclosed method also includes identifying a time period when the autonomous vehicle is to be operated in the commercial use, determining a zone within which the autonomous vehicle is to operate during the commercial use and directing, using a processor, the autonomous vehicle based on the time period and the zone.

### FIELD OF THE DISCLOSURE

This disclosure relates generally to autonomous vehicles and, more particularly, to methods and apparatus for commercial operation of personal autonomous vehicles.

### BACKGROUND

In recent years, autonomous vehicles have been developed to transport individuals, mainly their respective owners. To guide movement of these autonomous vehicles along designated routes for personal transportation, such autonomous vehicles typically utilize sensors (e.g., visual sensors, proximity sensors, etc.) in conjunction with map databases to maneuver/navigate along roads and traffic, and around other objects.

### SUMMARY

An example method includes determining that an owner of a personal autonomous vehicle has authorized the autonomous vehicle for commercial use. The example method also includes identifying a time period when the autonomous vehicle is to be operated in the commercial use, determining a zone within which the autonomous vehicle is to operate during the commercial use and directing, using a processor, the autonomous vehicle based on the time period and the zone.

An example method of directing commercial use of a personal autonomous vehicle includes changing a status of the autonomous vehicle to the commercial use based on an authorization from a computing device corresponding to an owner of the autonomous vehicle, where the owner provides parameters of the commercial use via the computing device. The example method also includes directing the autonomous vehicle, using a processor, to operate during the commercial use based on the parameters.

An example apparatus includes a transceiver of a portable device to be communicatively coupled to an autonomous vehicle control system via a network, where the autonomous vehicle control system is communicatively coupled to an autonomous vehicle owned by an owner. The example apparatus also includes an application of the portable device to direct the autonomous vehicle control system to change a status of the autonomous vehicle between a commercial use and a personal use based on input provided by the owner.

An example system for commercial use of a personal autonomous vehicle includes a receiver to receive an authorization from an authorized user of the autonomous vehicle that is received from a computing device communicatively coupled with a network, where the authorization is to direct transition of the autonomous vehicle to the commercial use. The example system also includes an autonomous vehicle director to generate a travel schedule of the autonomous vehicle based on the received authorization.

### BRIEF DESCRIPTION OF THE DRAWINGS

FIG. 1 is an example autonomous vehicle in which the examples disclosed herein may be implemented.

FIG. 2 illustrates an example autonomous vehicle control system in accordance with teachings of this disclosure.

FIG. 3 is an example screenshot of a portable device illustrating an example implementation of a transition of an autonomous vehicle to commercial use using the example autonomous vehicle control system of FIG. 2.

FIGS. 4A-4E are example screenshots illustrating an example implementation of a request for the use of the autonomous vehicle using the example autonomous vehicle control system of FIG. 2.

FIGS. 5A-5C are example screenshots illustrating an example implementation of access of a compartment of the autonomous vehicle to load an object into the autonomous vehicle.

FIGS. 6A-6C are example screenshots illustrating an example implementation of access of the autonomous vehicle to remove the object from the autonomous vehicle.

FIG. 7 depicts an example item delivery storage compartment that may be implemented with the examples disclosed herein.

FIG. 8 illustrates an example autonomous vehicle directing system that may be used to implement the examples disclosed herein.

FIG. 9 is a flowchart representative of an example method that may be used to implement the example autonomous vehicle directing system of FIG. 8.

FIG. 10 is a flowchart representative of another example method that may be used to implement the example autonomous vehicle directing system of FIG. 8.

FIG. 11 is a flowchart representative of another example method that may be implemented with the example autonomous vehicle directing system of FIG. 8.

FIG. 12 is a block diagram of an example processor platform capable of executing machine readable instructions to implement the example methods of FIGS. 9, 10 and/or 11 and the autonomous vehicle directing system of FIG. 8.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts.

### DETAILED DESCRIPTION

Methods and apparatus for commercial operation of personal autonomous vehicles are disclosed. Autonomous vehicles are often used to drive a passenger and/or an owner of the autonomous vehicle from one location to another for personal use and are not typically used for other purposes besides transporting passengers/owners for personal use.

The examples disclosed herein enable commercial operation of personal autonomous vehicles by allowing an autonomous vehicle to transition or switch from personal use to commercial use based on an authorization or instruction from an owner and/or an authorized agent. In some examples, the owner and/or the authorized agent may use a portable device that includes a transceiver, which is communicatively coupled to an autonomous vehicle control system via a network, to direct or request this transition. In turn, the autonomous vehicle control system that is also communicatively coupled to the autonomous vehicle may direct the autonomous vehicle based on the instructions provided by the owner. In particular, an application of the portable device may be used by the owner to authorize the autonomous vehicle to transition from personal use to commercial use during a desired time period. In some examples, the owner may identify a time period when the autonomous vehicle is to be operated in the commercial use and/or a location, zone and/or region (e.g., distance and/or regional constraint) in which the autonomous vehicle is to operate during the commercial use.

In some examples, the commercial use includes delivery of a package. In such examples, to initiate a delivery of the package from a sender to a recipient, the sender may request use of the personal autonomous vehicle, which is communicatively coupled to an autonomous vehicle control network, by selecting the autonomous vehicle from multiple available personal autonomous vehicles. This request may also include a pickup location and/or at least one delivery location corresponding to the package. In some examples, once the request for package delivery is authorized, the autonomous vehicle is directed to a pickup location, where the sender opens a compartment using a provided first access code, for example, and places the package within the autonomous vehicle. In some examples, the autonomous vehicle can drive to a delivery location, where a recipient opens the compartment with a provided second access code to remove or unload the package from the autonomous vehicle. In some examples, the owner of the autonomous vehicle authorizes a specific type of commercial use from a group of selectable commercial uses.

In other examples, the commercial use includes a passenger pickup (e.g., autonomous passenger pickup), passenger ride and/or a shared ride service. In such examples, an owner authorizes and initiates this use via an application of a portable device. In some examples, after this commercial use has been approved by the owner, a ride request, which includes a pickup as well as a drop-off location is authorized, the autonomous vehicle is directed to the pickup location. In some examples, a door is opened by a passenger using a provided access code so that the passenger can enter the autonomous vehicle. After transporting the passenger to his or her requested destination, the autonomous vehicle may subsequently be directed to proceed to provide other passengers with rides.

As used herein, the term “commercial use” refers to any revenue-generating use and can encompass a personal autonomous vehicle being used for a delivery, providing a passenger with a ride, transporting an advertisement (e.g., a billboard) around a region for a specified scheduled time period (e.g., transporting the advertisement so that it is viewable), etc. As used herein, the term “ownership” refers to having control and/or authority to operate a vehicle and does not necessarily mean full ownership. As a result, “ownership,” as used herein can encompass a lessee or an owner with a lien, etc. As used herein, the term “owner” refers to an individual who is authorized to transition a personal autonomous vehicle from personal use to commercial use. Accordingly, the term “owner” can encompass any individual who purchases an autonomous vehicle, an agent, a lessee, a family member or friend who is authorized to operate or use the autonomous vehicle, etc.

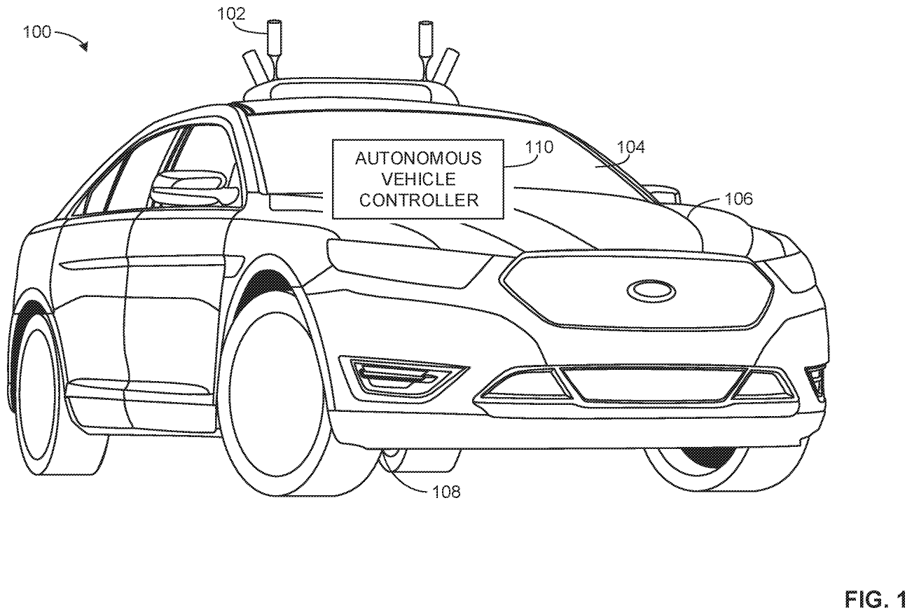

FIG. 1 is an example autonomous vehicle 100 in which the examples disclosed herein may be implemented. In the illustrated example of FIG. 1, the autonomous vehicle 100 includes an autonomous vehicle communication system 102, which includes a wireless transceiver, a cabin 104, an engine 106, a wheel steering system 108 and an autonomous vehicle controller 110.

To direct/guide movement of and/or navigate the example autonomous vehicle 100, the autonomous vehicle communication system 102 receives navigation and/or road condition data corresponding to the autonomous vehicle 100 such as GPS mapping data, weather condition data, road construction data, etc. In this example, sensor data received from sensors (e.g., visual sensors, proximity sensors, etc.) are processed by the example autonomous vehicle controller 110 to control the engine 106 (e.g., a throttle of the engine 106) in conjunction with the wheel steering system 108. The autonomous vehicle controller 110 of the illustrated example includes a GPS mapping unit and a sensor interface that utilizes positional information based on GPS mapping data to direct the engine 106 and the wheel steering system 108.

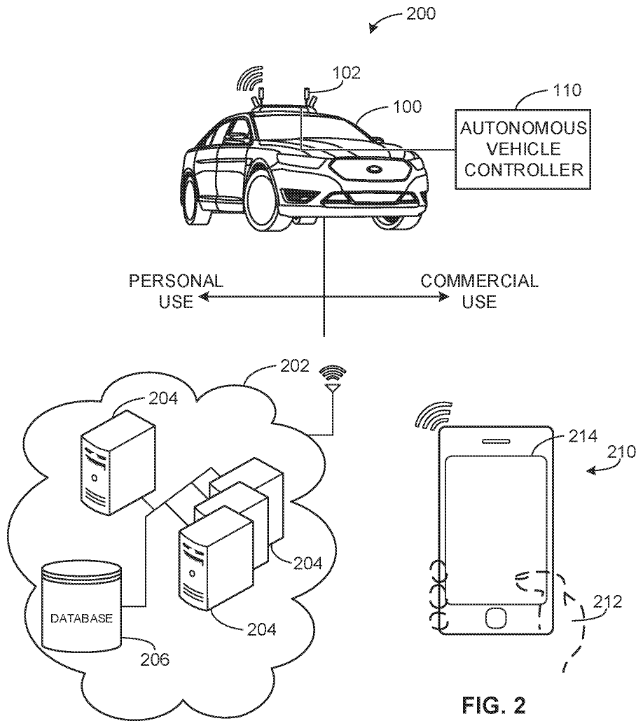

FIG. 2 is a schematic overview of an autonomous vehicle control system 200 in accordance with the teachings of this disclosure. In the illustrated example of FIG. 2, the autonomous vehicle control system 200 includes the autonomous vehicle communication system 102 and the autonomous vehicle controller 110 of the autonomous vehicle 100 of FIG. 1, an autonomous vehicle control network 202, which includes servers 204 and a database 206, and a portable device 210 that is operated by an owner 212 via a touch-screen 214. The example portable device 210 is communicatively coupled to the autonomous vehicle control network 202.

To direct a transition of the autonomous vehicle 100 from personal use and/or inactivity to commercial use, the owner 212 of the illustrated examples provides an input at the portable device 210 via the touch-screen 214 to change the operational status of the autonomous vehicle 100. According to the illustrated example, this input is transmitted from the portable device 210 to a transceiver of the autonomous vehicle control network 202, and in turn, this input is then relayed to the autonomous vehicle communication system 102 from the autonomous vehicle control network 202, which directs the autonomous vehicle 100 and/or the autonomous vehicle controller 110 to transition from personal use and/or inactivity to commercial use.

To specify one or more parameters (e.g., a delivery parameter, time period parameter, etc.) of the commercial use, for example, the owner 212, via the touch-screen 214 of the portable device 210, inputs a time period and/or a zone (e.g., an operating zone or area) in which the autonomous vehicle 100 will be operated during the commercial use. In turn, the example portable device 210 relays this provided input from the owner 212 to the autonomous vehicle control network 202. In some examples, the autonomous vehicle control network 202 transmits the time period and zone information to the autonomous vehicle communication system 102 and/or the autonomous vehicle controller 110 to control/direct the autonomous vehicle 100. In this example, the autonomous vehicle communication system 102 directs (e.g., directs movement and/or navigates) the autonomous vehicle 100 in the region during the time period. In some examples, the autonomous vehicle communication system 102 provides destination information to the autonomous vehicle 100 and/or the autonomous vehicle controller 110 and the autonomous vehicle 100 utilizes its own control systems, sensor systems and/or databases to navigate based on the destination information.

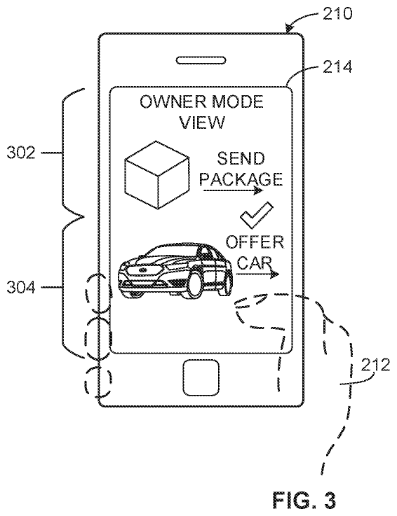

FIG. 3 is an example screenshot of the portable device 210 illustrating an example implementation of transitioning the autonomous vehicle 100 to commercial use, which is directed by the example autonomous vehicle control system 200 of FIG. 2. The touch-screen 214 of the illustrated example is shown as viewed by the owner 212. As can be seen in the illustrated example of FIG. 3, a first portion 302 of the touch-screen 214 illustrates an area, button and/or icon representing a selected type of commercial use for the autonomous vehicle 100 (e.g., delivery of a package, ride service, advertising, etc.). A second portion 304 of the example touch-screen 214 is an area, button and/or icon selected by the owner 212 to authorize and/or confirm commercial use of the autonomous vehicle 100. In some examples, the owner 212 does not select a type of commercial use (e.g., the owner 212 does not have a commercial use type preference).

In this example, to transition the autonomous vehicle 100 to commercial use, the owner 212 offers the autonomous vehicle 100 for commercial use by selecting and/or pressing the second portion 304 after selecting the type of commercial use at the first portion 302. In some examples, the owner 212 identifies a time period and/or region of operation in which the autonomous vehicle 100 is to operate. Additionally or alternatively, the owner 212 authorizes requests (e.g., specific requests) received from other users corresponding to requested commercial use of the autonomous vehicle 100. Further, in some examples, the owner 212 can direct the transition of the autonomous vehicle 100 from commercial use to personal use prior to an end of a commercial use time period (e.g., a designated commercial use time period).

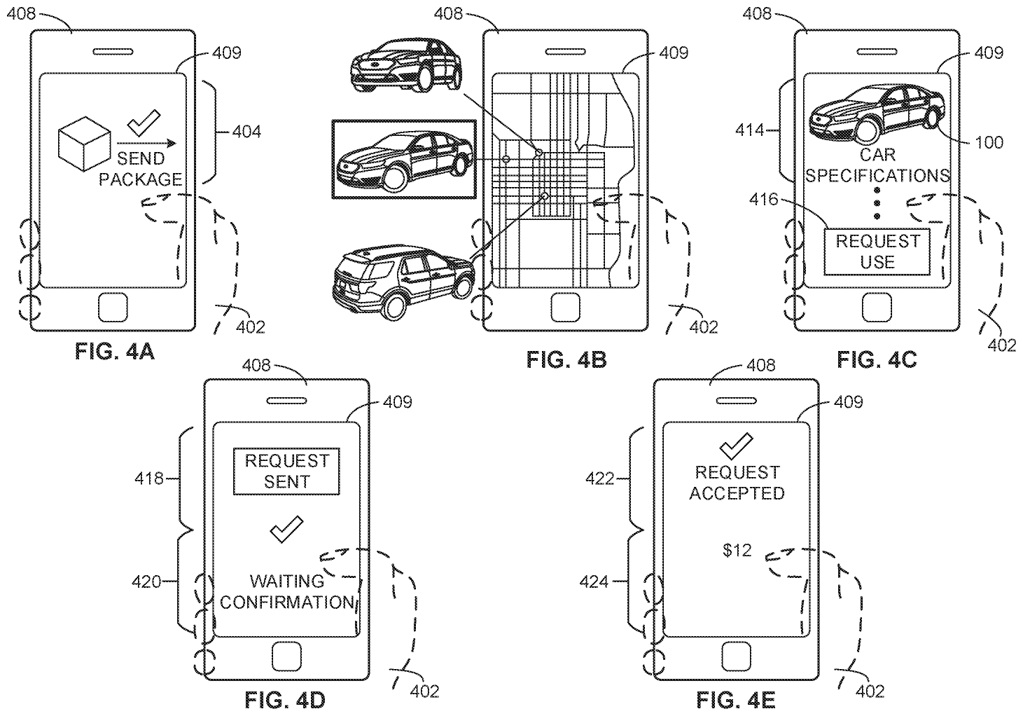

FIGS. 4A-4E are example screenshots illustrating an example implementation of requesting commercial use of the autonomous vehicle 100 via the example autonomous vehicle control system 200 of FIG. 2. Turning to FIG. 4A, a user 402 (e.g., a commercial use requester that is not an owner, a person requesting use of a personal vehicle owned by another person, etc.) requests commercial use of an autonomous vehicle by selecting an area, button and/or icon in a first portion 404 of a touch-screen 409 of a portable device 408 to communicate with the autonomous vehicle control system 200 to locate available autonomous vehicles within a region proximate and/or within a defined range of the user 402 that are available for commercial use during a specified time period by the user 402.

FIG. 4B is a screenshot illustrating selection of autonomous vehicles that are available for commercial use and located in a desired region (e.g., an area proximate the user 402). In some examples, the portable device 408 displays autonomous vehicles that fit within requested parameters provided by the user 402 (e.g., allowable pick up location(s) and/or desired drop-off location(s), etc.). For example, the portable device 408 may display autonomous vehicles that meet criteria provided by the user 402 (e.g., to carry more than 4 passengers, a truck that is able to store construction equipment, etc.). In some examples, the portable device 408 may display a profile for an autonomous vehicle when the user 402 selects the autonomous vehicle.

FIG. 4C illustrates a screenshot representing the user 402 requesting commercial use of the autonomous vehicle 100 at the portable device 408. In this example, the user 402 views autonomous vehicle specifications in a first portion 414 of the touch-screen 409 (e.g., the user 402 can return to the car selection shown in FIG. 4B based on viewing the vehicle specifications), and presses an icon or button 416 to initiate the portable device 408 and/or the autonomous vehicle control network 202 to select the autonomous vehicle 100. In some examples, a specific commercial use request made by the user 402 is forwarded to the owner 212 so that the owner 212 can authorize the specific commercial use request. Alternatively, in some examples, the request may be authorized by the autonomous vehicle control network 202 if the owner 212 has defined parameters and/or rules regarding previously permitted/defined commercial use(s) (e.g., the owner 212 has previously authorized commercial use and/or a commercial use within defined parameters by the user 402).

FIG. 4D is a screenshot illustrating a wait screen that may be viewed by the user 402 when waiting for the owner 212 to authorize the requested commercial use. In the illustrated example of FIG. 4D, the portable device 408 displays confirmation of the sent request in a first portion 418 of the touch-screen 409. Additionally, the portable device 408 displays a notification in a second portion 420 of the touch-screen 409 prompting the owner 212 to review the request. In this example, the owner 212 may reject the request and, in turn, the user 402 will be returned back to the screen of FIG. 4B. In other examples, upon authorization of the request, a confirmation is sent with a provided cost/fee to the user 402 to operate the autonomous vehicle 100 in the requested commercial use. In some examples where the user 402 has already been authorized to operate the autonomous vehicle 100 in a commercial use, the autonomous vehicle control network 202 will automatically direct the user 402 to the screen illustrated in FIG. 4E.

FIG. 4E is a screenshot illustrating how the user 402 may be informed that the owner 212 has authorized the commercial use. In the illustrated example of FIG. 4E, the portable device 408 displays confirmation of the owner 212 authorizing the specific request in a first portion 422 of the touch-screen 409. Additionally, the portable device 408 indicates the cost for the commercial use in a second portion 424 of the touch-screen 409. In some examples, this indication will also confirm that the user 402 has accepted the cost. Additionally or alternatively, the user 402 may negotiate the price with the owner 212 through the application (e.g., a back-and-forth negotiation dialogue/messaging process) and/or the autonomous vehicle control network 202. In some examples, the autonomous vehicle control network 202 coordinates and/or facilitates the transfer of funds between the owner 212 and the user 402.

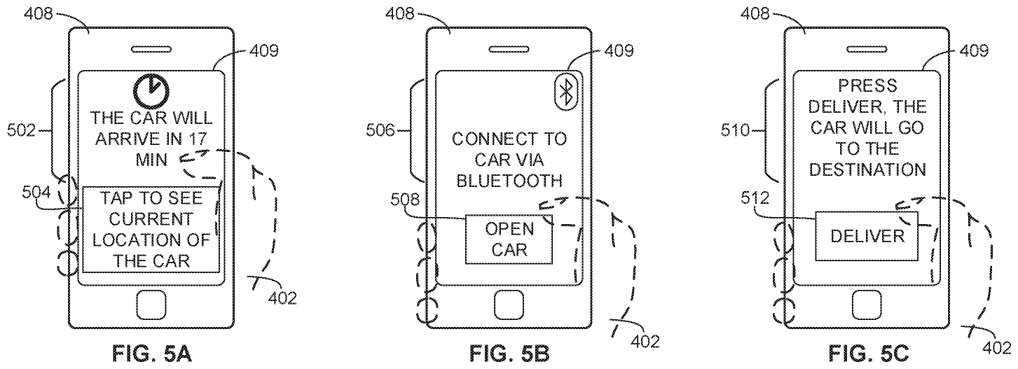

FIGS. 5A-5C are example screenshots illustrating an example implementation of accessing or opening a compartment (e.g., a glovebox, a trunk, etc.) and/or a cabin of the autonomous vehicle 100 using the portable device 408 so that a package may be placed by the user 402 within the autonomous vehicle 100, for example. According to the illustrated example of FIG. 5A, after the owner 212 has authorized the request from the user 402 for commercial use of the autonomous vehicle 100 via the autonomous vehicle control system 200, a first portion 502 of the touch-screen 409 includes a timer indicating an estimated arrival time of the autonomous vehicle 100. Additionally, the user 402 may press an icon or button 504 of the touch-screen 409 to view a map display indicating a current location of the autonomous vehicle 100.

Turning to FIG. 5B, to access or open the compartment of the autonomous vehicle 100, the owner 212 or the autonomous vehicle control network 202 transmits an access code and/or file (e.g., an encrypted access file) to the portable device 408 via the autonomous vehicle control network 202. As a result, the portable device 408 of the illustrated example prompts the user 402 in a first portion 506 of the touch-screen 409 to connect to the autonomous vehicle 100 via a wireless communication protocol (e.g., Cellular, Bluetooth, Wi-Fi, etc.) and, thus, the user 402 can open the compartment using the provided access code or file. In this example, the user 402 presses an icon or button 508 of the touch-screen 409 to open the compartment. Subsequently, the user 402 provides a package into the compartment. In some examples, the autonomous vehicle control network 202 provides an access file to the portable device 408 and, in turn, the portable device 408 transmits the access file to the autonomous vehicle 100 so that the compartment can be accessed. Alternatively, in examples corresponding to an automated ride service, the user 402 may enter the vehicle to be driven to a drop-off/destination location.

FIG. 5C illustrates delivery confirmation of the package in a first portion 510 of the touch-screen 409. In the illustrated example, the user 402 presses an icon or button 512 of the touch-screen 409 to direct the portable device 408 to communicate with the autonomous vehicle control network 202 via a wireless communication protocol (e.g., Cellular, Bluetooth, Wi-Fi, etc.) to direct the autonomous vehicle 100 to a delivery location.

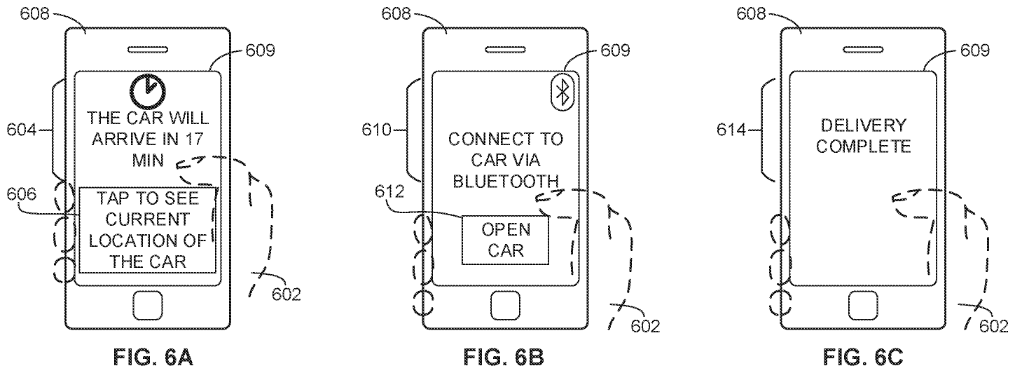

FIGS. 6A-6C are example screenshots illustrating an example implementation of accessing the autonomous vehicle 100 by a user 602 who is a package recipient in this example. To open the door and/or the compartment of the autonomous vehicle 100 so that the package may be removed, a first portion 604 of a touch-screen 609 of a portable device 608 displays a timer indicating an estimated arrival time in which the autonomous vehicle 100 is to arrive at a delivery location. Additionally, the user 602 may press an icon or button 606 of the touch-screen 609 to view a map display indicating a current location of the autonomous vehicle 100.

Turning to FIG. 6B, to access the compartment of the autonomous vehicle 100, an access code and/or file (e.g., an encrypted access file) is transmitted from the portable device 608 to the autonomous vehicle 100. For example, the portable device 608 prompts the user 602 in a first portion 610 of the touch-screen 609 to connect to the autonomous vehicle 100 via a wireless communication protocol (e.g., Cellular, Bluetooth, Wi-Fi, etc.) so that the user 602 can open the compartment based on authorization from the autonomous vehicle control network 202. In this example, the user 602 presses an icon or button 612 of the touch-screen 609 to open the compartment via a wireless connection between the autonomous vehicle 100 and the portable device 608. As a result, the user 602 of the illustrated example can remove the package from the compartment.

FIG. 6C illustrates a screenshot representing confirmation of delivery completion. In this example, the portable device 608 displays text in a first portion 614 of the touch-screen 609 to confirm delivery. This confirmation may be viewed by the owner 212, the user 402 and/or the user 602. Alternatively, in other examples, the owner 212 may receive a notification of a successful drop-off of a passenger.

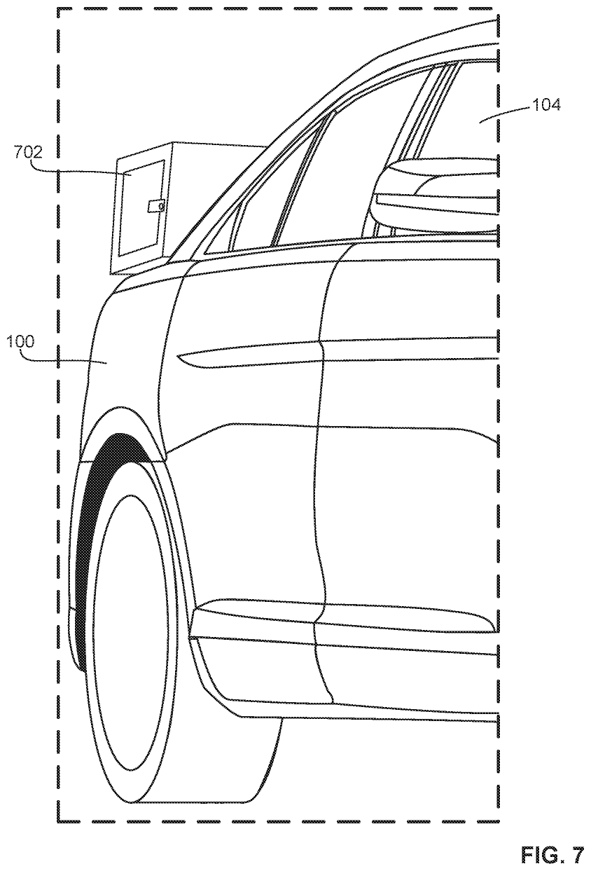

FIG. 7 illustrates an example item delivery storage compartment 702 that may be implemented with the examples disclosed herein. In this example, the storage compartment 702 is positioned external to the cabin 104 of the autonomous vehicle 100.

The example compartment 702 may be utilized to secure a delivery item or package without providing access to the cabin 104 and/or a trunk of the autonomous vehicle 100. In particular, the portable devices 408, 608 may be used to open the compartment 702 via authorization from the autonomous vehicle control system 200, thereby preventing access, theft and/or damage of the cabin 104.

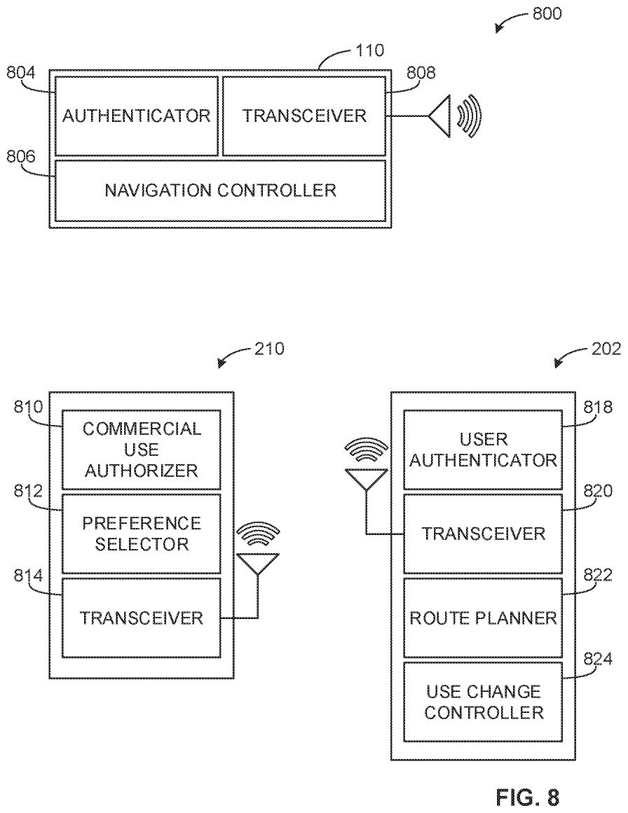

FIG. 8 illustrates an example autonomous vehicle directing system 800 that may be used to implement the examples disclosed herein. The example autonomous vehicle directing system 800 includes the autonomous vehicle controller 110, the autonomous vehicle control network 202 and the portable device 210. The example autonomous vehicle controller 110 includes an authenticator 804, a navigation controller 806 and a transceiver 808. The portable device 210 of the illustrated example includes a commercial use authorizer 810, a preference selector 812 and a transceiver 814. The example autonomous vehicle control network 202 includes a user authenticator 818, a transceiver 820, a route planner 822 and a use change controller 824.

The authenticator 804 of the illustrated example verifies received credentials of a user using the portable device 210 and compares the received credentials to a database to authenticate the user. In particular, the authenticator 804 may work in conjunction with the user authenticator 818, which receives the credentials from the portable device 210, to verify that the user is an owner of the autonomous vehicle 100. In some examples, the authenticator 804 compares an access code received at the transceiver 808 to an access code of a database to verify an authorization.

The example navigation controller 806 utilizes sensor data, navigation information, and/or route planning data received at the transceiver 808 to direct the autonomous vehicle 100. Specifically, the sensor data, the navigation information and/or the route planning data received at the transceiver 808 are processed by the navigation controller 806 to control the engine 106 (e.g., a throttle of the engine 106) in conjunction with the wheel steering system 108. In some examples, the navigation controller 806 receives destination and/or scheduling data from the route planner 822.

The commercial use authorizer 810 of the illustrated example authorizes the autonomous vehicle 100 for commercial use based on input(s) received at the portable device 210. In particular, the commercial use authorizer 810 transmits a request to the use change controller 824 and/or the user authenticator 818.

The example preference selector 812 provides preference data (e.g., time period, location of operation) provided by an owner, for example, pertaining to commercial use of the autonomous vehicle 100 to the autonomous vehicle control network 202. For example, the preference selector 812 may indicate parameters such as a commercial use type, a preference schedule and/or a preference region of operation provided by a portable device user and forward these parameters to the route planner 822.

The user authenticator 818 of the illustrated example verifies credentials of a user of the portable device 210 and compares the credentials to a server database to authenticate the user (e.g., to verify that the user is an owner). Additionally or alternatively, the user authenticator 818 verifies that portable device users are authorized to make commercial use requests.

The route planner 822 of the illustrated example processes data from the preference selector 812, GPS mapping information and/or commercial use parameters to generate a route of travel and/or a schedule of the autonomous vehicle 100 during its commercial use.

The example use change controller 824 transitions the autonomous vehicle 100 between personal and commercial use based on the authorization at the user authenticator 818.

In operation, to transition the autonomous vehicle 100 between commercial and personal use, the user authenticator 818 of the illustrated example verifies credential data received at the portable device 210 corresponding to a use change authorization request (e.g., by an application implemented by the portable device 210). In this example, the use change authorization request is relayed to the use change controller 824 which, in turn, sends a signal to the autonomous vehicle controller 110, thereby transitioning the autonomous vehicle 100 to the desired or requested use. In some examples, parameters related to the use change (e.g., an authorized type of use and/or an authorized zone of operation) are also relayed to the route planner 822 and/or the use change controller 824, thereby restricting the requested commercial use within the parameters.

To direct the autonomous vehicle 100 during a commercial use, the route planner 822 of the illustrated example provides route and/or destination information to the navigation controller 806 so that the navigation controller 806 can direct navigation/travel of the autonomous vehicle 100. In other examples, the route planner 822 directly controls movement and/or navigation of the autonomous vehicle 100 instead.

While an example manner of implementing the example autonomous vehicle control system 200 of FIG. 2 is illustrated in FIG. 8, one or more of the elements, processes and/or devices illustrated in FIG. 8 may be combined, divided, re-arranged, omitted, eliminated and/or implemented in any other way. Further, the example authenticator 804, the example navigation controller 806, the example commercial use authorizer 810, the example preference selector 812, the example user authenticator 818, the example route planner 822, the example use change controller 824 and/or, more generally, the example autonomous vehicle directing system 800 of FIG. 8 may be implemented by hardware, software, firmware and/or any combination of hardware, software and/or firmware. Thus, for example, any of the example authenticator 804, the example navigation controller 806, the example commercial use authorizer 810, the example preference selector 812, the example user authenticator 818, the example route planner 822, the example use change controller 824 and/or, more generally, the example autonomous vehicle directing system 800 of FIG. 8 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, the example authenticator 804, the example navigation controller 806, the example commercial use authorizer 810, the example preference selector 812, the example user authenticator 818, the example route planner 822 and/or the example use change controller 824 is/are hereby expressly defined to include a tangible computer readable storage device or storage disk such as a memory, a digital versatile disk (DVD), a compact disk (CD), a Blu-ray disk, etc. storing the software and/or firmware. Further still, the example autonomous vehicle directing system 800 of FIG. 8 may include one or more elements, processes and/or devices in addition to, or instead of, those illustrated in FIG. 8, and/or may include more than one of any or all of the illustrated elements, processes and devices.

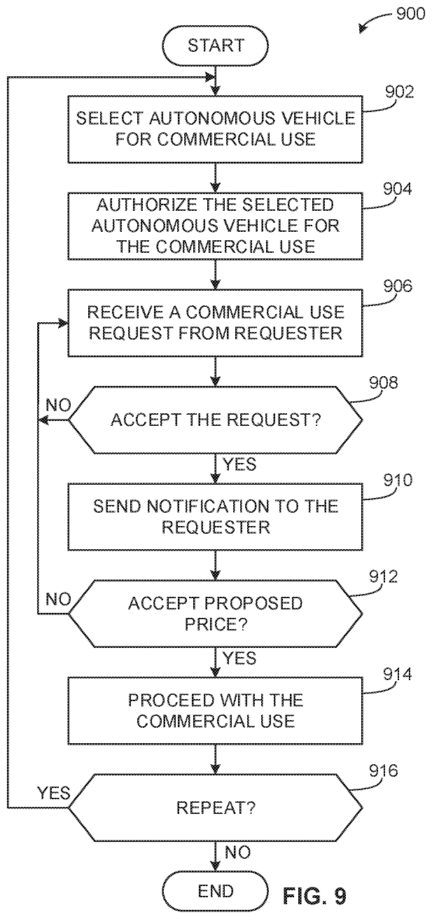

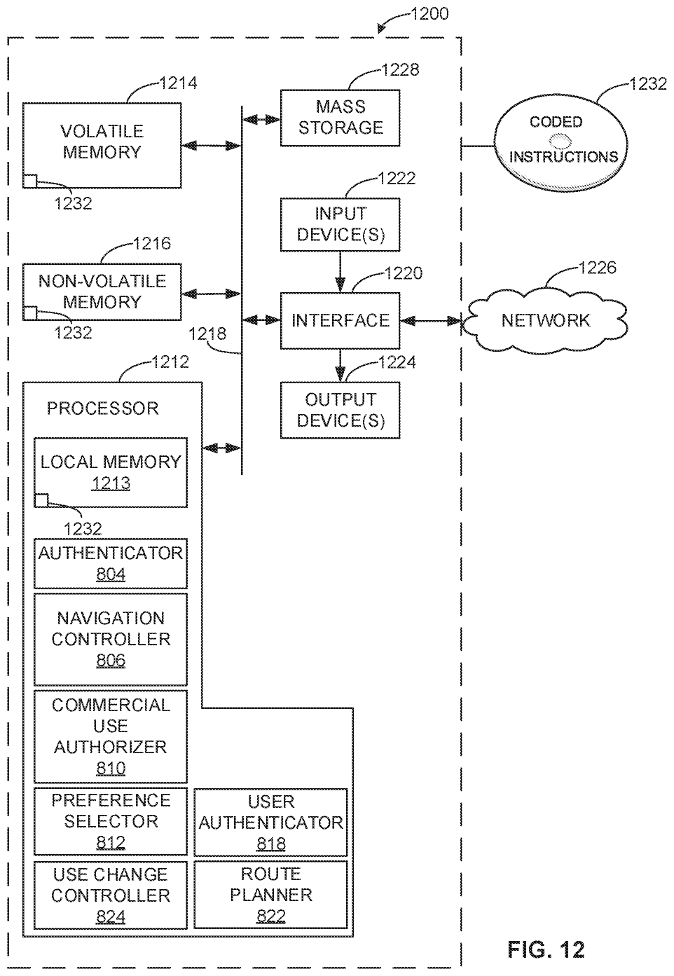

Flowcharts representative of example methods for implementing the example autonomous vehicle directing system 800 of FIG. 8 are shown in FIGS. 9, 10 and 11. In these examples, the methods may be implemented using machine readable instructions that comprise a program for execution by a processor such as the processor 1212 shown in the example processor platform 1200 discussed below in connection with FIG. 12. The program may be embodied in software stored on a tangible computer readable storage medium such as a CD-ROM, a floppy disk, a hard drive, a digital versatile disk (DVD), a Blu-ray disk, or a memory associated with the processor 1212, but the entire program and/or parts thereof could alternatively be executed by a device other than the processor 1212 and/or embodied in firmware or dedicated hardware. Further, although the example program is described with reference to the flowcharts illustrated in FIGS. 9, 10 and 11, many other methods of implementing the example autonomous vehicle directing system 800 may alternatively be used. For example, the order of execution of the blocks may be changed, and/or some of the blocks described may be changed, eliminated, or combined.

As mentioned above, the example methods of FIGS. 9, 10 and 11 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example methods of FIGS. 9, 10 and 11 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The example method 900 of FIG. 9 begins as an owner is about to direct a transition of an autonomous vehicle, which is owned or operated by the owner, from a personal use to commercial use.

According to the illustrated example, the owner selects the autonomous vehicle for commercial use (block 902). In particular, the owner utilizes an application of the portable device 210 that transmits a corresponding signal to the use change controller 824 and/or the user authenticator 818 of the autonomous vehicle control network 202. In some examples, the owner may have multiple autonomous vehicles to choose from on the portable device 210.

According to the illustrated example, upon receiving the request from the portable device 210, the example commercial use authorizer 810 authorizes the selected autonomous vehicle for the commercial use (block 904). In particular, the example commercial use authorizer 810 directs the use change controller 824 to transition the autonomous vehicle to the commercial use.

In this example, a request to authorize a commercial use from a requester is received (block 906). In particular, a specific request that indicates a type of commercial use (e.g., package delivery, etc.) is received at the transceiver 820 from a portable device of a user.

It is then determined whether the request is accepted (block 908). If the user authenticator 818 authorizes the request (block 908), control of the process proceeds to block 910. Otherwise, control of the process returns to block 906 in this example.

According to the illustrated example, upon authorization of the request received from the user, the user authenticator 818 and/or the autonomous vehicle control network 202 sends a notification to the user (block 910). In some examples, a proposed price is transmitted to the user and/or the owner. Additionally or alternatively, negotiations of the proposed price are facilitated by the autonomous vehicle control network 202.

In examples where price of the commercial use is agreed upon and/or negotiated, it is determined whether a proposed price is accepted by the owner (block 912). If the owner accepts the proposed price (block 912), control of the process proceeds to block 914. Otherwise, control of the process returns to block 906. In particular, when the proposed price is denied by the user, the user authenticator 818, the use change controller 824 and/or the autonomous vehicle control network 202 may wait to receive another request.

According to the illustrated example, when the proposed price is accepted, the commercial use authorizer 810 and/or the use change controller 824 directs the autonomous vehicle to proceed with the commercial use (block 914).

Next, it is determined whether the process is to be repeated (block 916). In some examples, this determination is made by the preference selector 812, which determines if the commercial use period has been exceeded, or whether the owner has manually ended the commercial use. If the process is to be repeated (block 916), control of the process proceeds to block 902. Otherwise, the process ends.

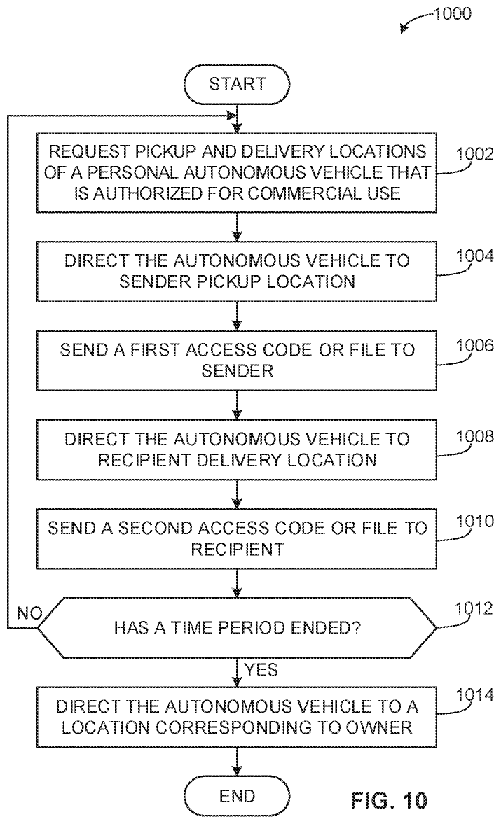

The example method 1000 of FIG. 10 begins as a user is about to request use of an owner's personal autonomous vehicle, which has been authorized for commercial use. According to the illustrated example, the user requests pickup and delivery locations of the personal autonomous vehicle (block 1002).

According to the illustrated example, upon receiving the route information from the autonomous vehicle control network 202, the example navigation controller 806 directs the autonomous vehicle to a sender pickup location (block 1004). In particular, the user of the illustrated example utilizes an application of a portable device that transmits a signal to the route planner 822, which generates a route based on the pickup and delivery locations and transmits the route information to the navigation controller 806 of the autonomous vehicle controller 110.

At block 1006, the commercial use authorizer 810 and/or the user authenticator 818 transmit a first access code or file so that the sender can open a compartment of the autonomous vehicle. In particular, the example user authenticator 818 transmits the access code or file to the authenticator 804 of the autonomous vehicle controller 110 to enable the user to open the compartment.

According to the illustrated example, the navigation controller 806 directs the autonomous vehicle to the recipient location (block 1008).

In this example, the commercial use authorizer 810 and/or the user authenticator 818 transmit a second access code or file to the authenticator 804 so that the recipient can open the compartment (block 1010).

In examples where the autonomous vehicle is operating in commercial use, it is determined if a commercial use time period has ended (block 1012). If the time period has ended (block 1012), control of the process proceeds to block 1014. Otherwise, control of the process returns to block 1002. For example, if the commercial use time period has not ended, the route planner 822 and/or the autonomous vehicle control network 202 may wait for a predefined time duration to receive further commercial use requests.

In some examples, when the time period has ended, the navigation controller 806 directs the autonomous vehicle to a location corresponding to the owner (block 1014) and the process ends.

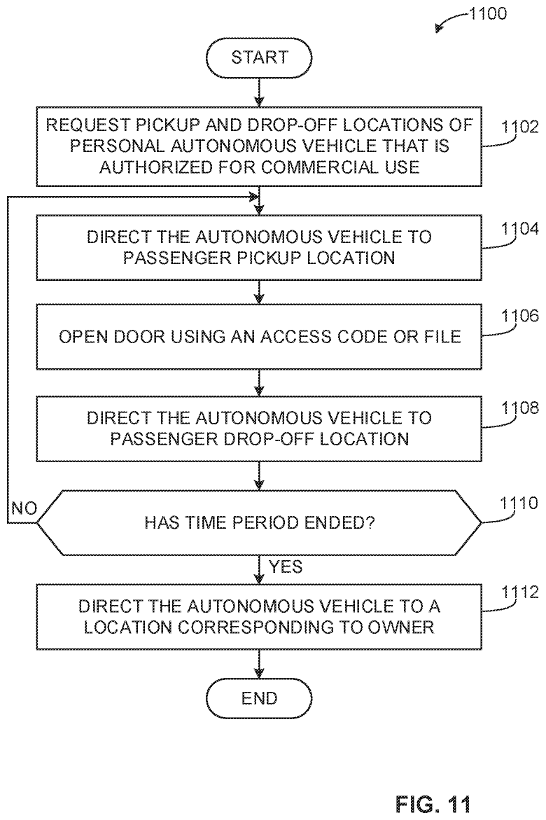

The example method 1100 of FIG. 11 begins as a user that has been authenticated by the user authenticator 818 is about to requests a personal autonomous vehicle that has been authorized for commercial use. In particular, the user of the illustrated example is requesting commercial use related to a passenger ride.

According to the illustrated example, the user requests pickup and drop-off locations of the personal autonomous vehicle that is authorized for commercial use (block 1102). In particular, the user utilizes an application of a portable device to transmit a signal to the route planner 822 of the autonomous vehicle control network 202. For example, the route planner 822 generates a route based on the requested pickup and drop-off locations and transmits the route information to the navigation controller 806 of the autonomous vehicle controller 110.

According to the illustrated example, upon receiving the route information from the autonomous vehicle control network 202, the example navigation controller 806 and/or the route planner 822 directs and/or navigates the autonomous vehicle to a passenger pickup location (block 1104).

In this example, the commercial use authorizer 810 and/or the user authenticator 818 send and authorize a first access code or file to the user to open a door (block 1106). Specifically, the portable device to transmit the access code or file via the user authenticator 818 and/or the authenticator 804 of the autonomous vehicle controller 110 to open the door.

In some examples, upon the passenger entering the autonomous vehicle, the navigation controller 806 directs the autonomous vehicle to the drop-off location (block 1108).

In examples where the autonomous vehicle is operating at a commercial use, it is determined if a time period has ended (block 1110). If the time period has ended (block 1110), control of the process proceeds to block 1112. Otherwise, control of the process returns to block 1104.

In some examples, when the time period has ended, the navigation controller 806 directs the autonomous vehicle to a location corresponding to the owner (block 1112) and the process ends.

FIG. 12 is a block diagram of an example processor platform 1200 capable of executing the instructions to implement the example methods of FIGS. 9, 10 and 11 to implement the autonomous vehicle directing system of FIG. 8. The processor platform 1200 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors or controllers from any desired family or manufacturer.

The processor 1212 of the illustrated example includes a local memory 1213 (e.g., a cache). In this example, the processor 1212 includes the example authenticator 804, the example navigation controller 806, the example commercial use authorizer 810, the example preference selector 812, the example user authenticator 818, the example route planner 822 and the example use change controller 824. The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), and/or a PCI express interface.

In the illustrated example, one or more input devices 1222 are connected to the interface circuit 1220. The input device(s) 1222 permit(s) a user to enter data and commands into the processor 1212. The input device(s) can be implemented by, for example, an audio sensor, a microphone, a camera (still or video), a keyboard, a button, a mouse, a touch-screen, a track-pad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display, a cathode ray tube display (CRT), a touch-screen, a tactile output device, a printer and/or speakers). The interface circuit 1220 of the illustrated example, thus, typically includes a graphics driver card, a graphics driver chip or a graphics driver processor.

The interface circuit 1220 of the illustrated example also includes a communication device such as a transmitter, a receiver, a transceiver, a modem and/or network interface card to facilitate exchange of data with external machines (e.g., computing devices of any kind) via a network 1226 (e.g., an Ethernet connection, a digital subscriber line (DSL), a telephone line, coaxial cable, a cellular telephone system, etc.).

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, RAID systems, and digital versatile disk (DVD) drives.

Coded instructions 1232 to implement the methods of FIGS. 9, 10 and 11 may be stored in the mass storage device 1228, in the volatile memory 1214, in the non-volatile memory 1216, and/or on a removable tangible computer readable storage medium such as a CD or DVD.

From the foregoing, it will be appreciated that the above disclosed methods, apparatus and articles of manufacture enable transition of a personal autonomous vehicle from personal use to commercial use and vice-versa, thereby allowing revenue-generating use of the autonomous vehicle when it would be otherwise just sitting. As a result, the examples disclosed herein enable an owner of an autonomous vehicle to generate revenue during designated time periods. In some examples, route planning may allow the owner to use the autonomous vehicle after the commercial use (e.g., the autonomous vehicle picks up the owner at work after the commercial use).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method comprising:
determining that an owner of a personal autonomous vehicle has authorized the autonomous vehicle for commercial use;
identifying a time period when the autonomous vehicle is to be operated in the commercial use;
determining a zone within which the autonomous vehicle is to operate during the commercial use; and
directing, using a processor, the autonomous vehicle based on the time period and the zone.

2. The method of claim 1, wherein the time period is identified by the owner of the autonomous vehicle.

3. The method of claim 1, wherein the zone is determined by an input from a user, wherein the input includes a pickup location and at least one delivery parameter.

4. The method of claim 3, further including directing the autonomous vehicle to the pickup location; and wherein the delivery parameter includes a delivery location identified by the user.

5. The method of claim 4, further including directing the autonomous vehicle to the delivery location identified by the user.

6. The method of claim 1, wherein the commercial use includes autonomous passenger pickup and drop-off.

7. The method of claim 1, further including directing the autonomous vehicle to a location of the owner at a time subsequent the identified time period.

8. A method of directing commercial use of a personal autonomous vehicle comprising:
changing a status of the autonomous vehicle to the commercial use based on an authorization from a computing device corresponding to an owner of the autonomous vehicle, wherein the owner provides parameters of the commercial use via the computing device; and
directing the autonomous vehicle, using a processor, to operate during the commercial use based on the parameters.

9. The method of claim 8, wherein the parameters include a scheduled time period for the autonomous vehicle to operate in the commercial use.

10. The method of claim 8, wherein the commercial use includes delivery.

11. The method of claim 10, further including transmitting an access code to a delivery recipient to open a compartment of the autonomous vehicle.

12. The method of claim 11, wherein the compartment is located external to a cabin of the autonomous vehicle.

13. The method of claim 8, wherein the commercial use includes pickup and drop-off of passengers.

14. (canceled)

15. (canceled)

16. (canceled)

17. A system for commercial use of a personal autonomous vehicle, the system comprising:
a receiver to receive an authorization from an authorized user of the autonomous vehicle that is received from a computing device communicatively coupled with a network, the authorization to direct transition of the autonomous vehicle to the commercial use; and
an autonomous vehicle director to generate a travel schedule of the autonomous vehicle based on the received authorization.

18. The system of claim 17, wherein the authorization identifies a time period when the autonomous vehicle will transition back to personal use from the commercial use.

19. The system of claim 18, further including directing the autonomous vehicle to a location of the authorized user after the autonomous vehicle transitions from the commercial use to the personal use.

20. The system of claim 19, wherein an autonomous vehicle director directs the autonomous vehicle to a pickup location associated with a first user and a delivery location associated with a second user during the commercial use.

21. The method of claim 1, wherein the commercial use includes transporting an advertisement.

22. The method of claim 8, wherein the parameters include a preferred area of operation for the autonomous vehicle during the commercial use.

23. The system of claim 17, wherein the authorization identifies a preferred area of operation for the autonomous vehicle during the commercial use.
